(19) United States
(12) Patent Application Publication
(10) Pub. No.: US 2006/0287966 A1
(43) Pub. Date: Dec. 21, 2006

(54) Methods and systems for authoring customized contracts using contract templates that include user-configured rules and questions

(75) Inventors: Ashok Srinivasaraghavan, Fremont, CA (US); Taheri Saifee, Fremont, CA (US); Angela Makalintal, Sunnyvale, CA (US); Arun Sundaramoorthy, Santa Clare, CA (US); Vijayanand Rajkumar, Redwood City, CA (US); Rhonda Stieber, Los Altos, CA (US)

Correspondence Address: YOUNG LAW FIRM, P.C., 4370 ALPINE RD., STE. 106, PORTOLA VALLEY, CA, 94028, US

(73) Assignee: ORACLE INTERNATIONAL CORPORATION, REDWOOD SHORES, CA (US)

(21) Appl. No.: 11/020,605

(22) Filed: Dec. 21, 2004

(51) Int. Cl. G06Q 99/00; H04L 9/00; H04K 1/00

(52) U.S. Cl. 705/80; 705/1

(57) ABSTRACT

A computer-implemented method of authoring a contract may include steps of providing a database that includes a plurality of selectable contract clauses and a plurality of selectable contract templates, each of the plurality of contract templates including a plurality of rules, each of the plurality of rules being configured to incorporate at least one selected contract clause into the contract to be authored depending upon an evaluation of the rule. The user may then be required to select a contract template from among a plurality of contract templates and each of the plurality of rules in the selected contract template may then be evaluated, along with any global rules that may be present. User responses may then be received when one or more of the rules in the selected contract template includes question(s) requiring a response by the user. It is then determined whether one or more additional contract clauses should be included in the contract depending on the evaluation step and any received user responses. When the determining step determines that a contract clause should be added to the contract, the method may include steps of selecting and retrieving from the database, one or more contract clauses for inclusion in predetermined sections of the contract, and the contract may then be generated based upon the selected contract template

### BACKGROUND OF THE INVENTION

1. Field of the Invention

The present invention relates to methods and systems for authoring contracts. More particularly, embodiments of the present invention enable contracts to be automatically created and modified using dynamically configured rules that construct a contract based on the specifics of a deal and responses to user-defined questions.

2. Description of the Prior Art and Related Information

Authoring complex contracts is a very involved process requiring significant investment of time and resources. All contractual terms have legal repercussions and it is important for a business to be able to standardize contractual terms and conditions that are most advantageous and that will protect the company from undue risk. These terms and conditions must be used consistently and correctly and often this requires deep, specialized knowledge. In addition, when contracting with government entities, additional rules and regulations apply that dictate the terms and conditions that are appropriate and required for different contractual situations. It is important that these rules be followed precisely in authoring contracts that are to stand up to scrutiny. Errors in contract authoring can cost corporations dearly, both in terms of dollars and relationships with trading partners.

Currently, most corporations author their contracts manually using a word processor such as Microsoft Word. In order to ensure that a contract includes the correct terms and conditions, businesses must rely on costly manual processing, and highly skilled contract administrators. These contract administrators must have deep knowledge of the company's contracting process, and must stay up to date on all the changing rules regarding contractual terms and conditions (both internal standards as well as legal and government regulations). For example, for government contracts, governmental agencies need to author contract based on the Federal Acquisition Regulations (FAR), which specify the contractual clauses (or articles) that must be used. In most cases, the governmental contract administrators must manually construct the appropriate terms and conditions for the contract and ensure that they are correct, legal and current. Mistakes are easily made and can be very costly.

### SUMMARY OF THE INVENTION

Embodiments of the present invention include a computer-implemented method of authoring a contract that includes steps of providing a database that includes a plurality of selectable contract clauses and a plurality of selectable contract templates, each of the plurality of contract templates including a plurality of rules, each of the plurality of rules being configured to incorporate at least one selected contract clause into the contract to be authored depending upon an evaluation of the rule; selecting a contract template from among a plurality of contract templates; evaluating each of the plurality of rules in the selected contract template; receiving a user response to a question when at least one of the plurality of rules in the selected contract template includes a question requiring a response by the user; determining whether one or more additional contract clauses should be added to the contract depending on the evaluation step and any received user responses; when the determining step determines that a contract clause should be added to the contract, selecting and retrieving from the database, at least one contract clause for inclusion in the contract, and generating a customized contract based upon the selected contract template, the customized contract being configured to include at least one selected and retrieved contract clause.

One or more of the rules may be user-defined. The rule may include one or more user-defined questions. The user response may be a forced choice that is constrained to a specific type of answer or to a predefined number of possible values. The specific type of answer may include YES/NO or numerical answers, for example. The user-defined rules may be configured to accept as an answer only a value selected from a provided list of values. The user-defined rule may include a Boolean operator. The user-defined rule is configured to selectively cause execution of another rule depending upon an answer provided by the user in response to the user-defined question.

The present invention, according to another embodiment thereof, is a computer readable medium having data stored thereon representing sequences of instructions which, when executed by a computing device, causes the computing device to author a contract by carrying out steps including providing a database that may include a plurality of selectable contract clauses and a plurality of selectable contract templates, each of the plurality of contract templates including a plurality of rules, each of the plurality of rules being configured to incorporate at least one selected contract clause into the contract to be authored depending upon an evaluation of the rule; selecting a contract template from among a plurality of contract templates; evaluating each of the plurality of rules in the selected contract template; receiving a user response to a question when at least one of the plurality of rules in the selected contract template may include a question requiring a response by the user; determining whether one or more additional contract clauses should be added to the contract depending on the evaluation step and any received user responses; when the determining step determines that a contract clause should be added to the contract, selecting and retrieving from the database, at least one contract clause for inclusion in the contract, and generating a customized contract based upon the selected contract template, the customized contract being configured to include the at least one selected and retrieved contract clause.

The present invention, according to another embodiment thereof, is a computer system for authoring a contract, the computer system comprising: at least one processor; at least one data storage device coupled to the at least one processor; a plurality of processes spawned by said at least one processor, the processes including processing logic for: providing a database that may include a plurality of selectable contract clauses and a plurality of selectable contract templates, each of the plurality of contract templates including a plurality of rules, each of the plurality of rules being configured to incorporate at least one selected contract clause into the contract to be authored depending upon an evaluation of the rule; selecting a contract template from among a plurality of contract templates; evaluating each of the plurality of rules in the selected contract template; receiving a user response to a question when at least one of the plurality of rules in the selected contract template may include a question requiring a response by the user; determining whether one or more additional contract clauses should be added to the contract depending on the evaluation step and any received user responses; when the determining step determines that a contract clause should be added to the contract, selecting and retrieving from the database, at least one contract clause for inclusion in the contract, and generating a customized contract based upon the selected contract template, the customized contract being configured to include the at least one selected and retrieved contract clause.

### BRIEF DESCRIPTION OF THE DRAWINGS

FIG. 1 is a representation of a user interface for creating a Yes/No question upon which one or more clause selection rules may be based, according to an embodiment of the present invention.

FIG. 2 is a representation of a user interface for creating a question having a numerical response type upon which one or more clause selection rules may be based, according to an embodiment of the present invention.

FIG. 3 is a representation of a user interface for creating a question having a list of values response type upon which one or more clause selection rules may be based, according to an embodiment of the present invention.

FIG. 4 is a representation of a user interface for searching for questions, according to an embodiment of the present invention.

FIG. 5 is a flowchart of a method of creating a customized contract, according to an embodiment of the present invention.

FIG. 6 is a block diagram of a computer with which aspects of embodiments of the present invention may be practiced.

### DETAILED DESCRIPTION

According to an embodiment of the present invention is a computer-implemented contract expert software application that provides an automated, rules-based approach for applying the correct terms and conditions to a contract. Recognizing that the business and legal landscapes change often, embodiments of the present invention enable users to define new rules and new questions and to specify the allowable manually input answers to the user-defined questions. The answers to such user-defined questions may, in turn, be used by one or more clause selection rules to determine which clauses are to be selected for inclusion in a customized contract. The present contract expert application, therefore, enables users to set up logical clause selection rules that can be used to author a contract. The evaluation of the user-defined rules and the application of user input in response to questions posed by such user-defined rules dictate which clauses (clauses or contractual text) are to be included in the contract being created. These clause selection rules may be used to model the government FAR regulations, or (any other business) internal contractual standards. For example, the rules may be used to include specific contract text if certain products are sold (such as hazardous materials, for example). Embodiments of the present invention provide an automated application that ensures that contract content is correct and standardized based on the business situation and complies with all relevant appropriate rules and regulations. Embodiments of the present invention enable even non-expert users to draft relatively complex customized contracts accurately, thereby reducing both errors and corporate exposure to risk.

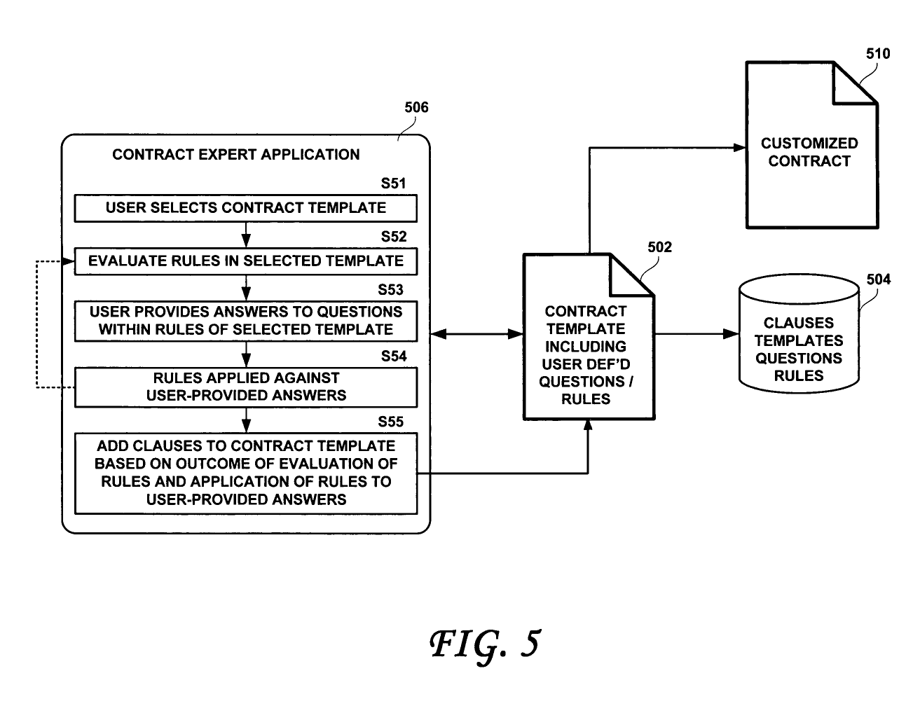

As shown in FIG. 5, to create a contract, the user must select a contract template 502 that is appropriate to the contract the user wishes to create, as shown at S51. A plurality of contract templates may be stored in a database 504. Each contract template 502 may contain a plurality of user-defined rules and a plurality of clauses appropriate for the type of template selected. One or more of the rules contained within each template 502 may include one or more user-defined questions that require user input. The user-provided answers to the user-defined questions are evaluated against one or more user-defined rules within the selected template, which drives the selection and incorporation of additional clauses into the customized contract 510 being created. As shown at step S52, a contract expert application 506, as described herein, may then be run on the selected contract template 502 to incorporate in additional clauses based on criteria including items, item categories, payment terms and other business terms in the document, if the evaluation of the user-defined rules dictates that such additional clauses should be incorporated into the contract. The contract expert application 506 may also determine that one or more clauses should be removed from the contract or that another clause should be substituted for one or more clauses in the contract. As suggested at S53, when the contract expert application 506 is run, users may be required to provide responses to questions defined within one or more rules, which user-provided responses are then used by further user-defined clause selection rules to drive further clause selections. The user-defined rules may, but need not, include user-defined questions. As the user provides the requested answers to the user-defined questions within the rules of the selected template 502, further rules within the selected template are applied against the provided answers, which may cause the selection and inclusion of further clauses in the customized contract 510 being created, as shown at S55. All of the clauses that are recommended or required by the contract expert application 506 may then be brought into (incorporated into) the customized contract and organized under appropriate sections. The resulting document 510 is then the final customized contract. The contract expert application 506 may thereafter be run periodically on the customized contract 510 to ensure that the contract 510 contains all the appropriate clauses based on the latest set of business rules.

The contract expert application 506 may select and access a contract template 502 from among a plurality of contract templates stored in the database 504. The contract template may include one or more user-defined rules and one or more pre-seeded clauses. One or more of the user-defined rules may include one or more user-defined questions. Steps S52-S55 may be repeated as required by the user-defined rules of the selected template 502. It should be noted, however, that the selected template 502 may not include any rules that require user-provided responses.

When the user-defined rules within the selected contract template 502 have been applied, the customized contract 510 is generated. The customized contract 510 may include the pre-seeded clauses within the selected contract template 502 and may also include one or more clauses that were incorporated following evaluation of the user-defined rules and any user-defined questions contained within the user-defined rules. Likewise, the customized contract 510 may lack one or more clauses that were previously present in the template 502, as one or more clauses in the customized contract 510 may have been excluded (i.e., taken out) of the template 502 as a result of the application of the user-provided answers to the rules of the template 502.

Clauses are the text of the contract. More particularly, articles or clauses (as the terms are used interchangeably herein) represent the terms and conditions of the contract expressed as text. Standard clauses may be kept in a database 504 and may be used in many contracts. Version numbers may be associated with each or some of the standard clauses. If more than one instance of a particular standard clause exists in the contract terms library (a repository of contract clauses), the version numbers associated therewith indicate which standard clause is the most current. When a clause is inserted or otherwise incorporated into a contract, the most recent release of that clause is preferably used, as indicated by that clause's version number. In this manner, rules may be considered as contract terms and conditions with the addition of computer-readable formatting that causes the application 506 incorporating embodiments of the present invention to take action based on the user-provided information.

Custom clauses are non-standard clauses that may be created in the context of a single contract, and may also be stored in the database 504, 510. Non-standard clauses may be either written by the author of the contract or copied from the contract terms library and thereafter modified.

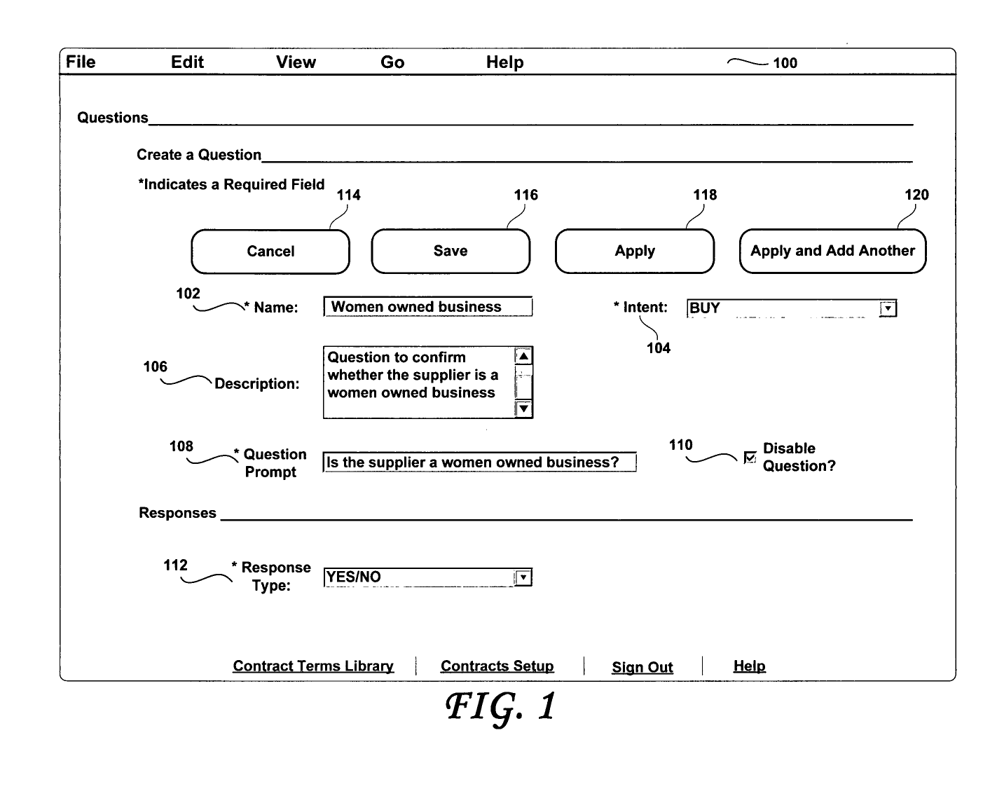

FIG. 1 shows an exemplary user interface according to an embodiment of the present invention, for creating a user-defined question. The answer to such a question may be used by one or more rules to drive clause selection within the customized contract 510 being created. The user interface 100 for creating a user-defined question may include a name field 102, which is a short name to identify the question. A field 104 to identify whether the question is intended for buy or sell intent contracts may also be provided. Numeral 106 references a description field to enable the creator of the question to enter a prose description of the nature and purpose of the question. A question prompt is shown at 108, enabling the creator of the question to choose the wording of the question that will be displayed at runtime for the user to respond. A question disable checkbox may also be provided as shown at reference numeral 110, to enable a user to disable a question to prevent it from being used in a rule. As with questions, rules may be selectively configured to be active or inactive. In contrast to active rules, inactive rules cannot operate to incorporate any clauses into a contract and cannot operate to take out any clause from a contract. Returning to FIG. 1, the user interface 100 may also include a Cancel button 114, which allows the user to exit the create page without saving any changes, and a Save button 116, the depressing of which causes the application 506 to validate the newly-created question and to remain on the same page. If the newly-created question fails validation, the system may remain on the current page and may provide an appropriate error message. An Apply button 118 may also be provided, the depressing of which causes the application 506 to validate the newly-created question and may return to another page. If the newly-created question fails validation, the system may remain on the page and may provide an appropriate error message. An Apply and Add Another button 120 may also be provided, the depressing of which causes the application 506 to validate the newly-created question and to open a new ‘Create Question’ page.

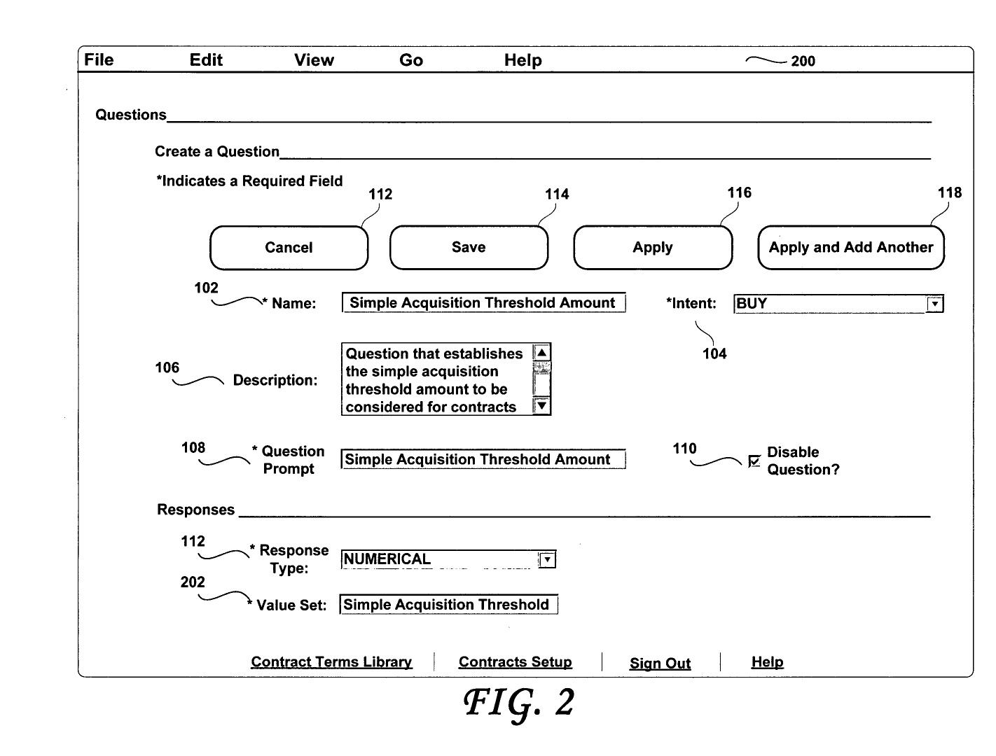

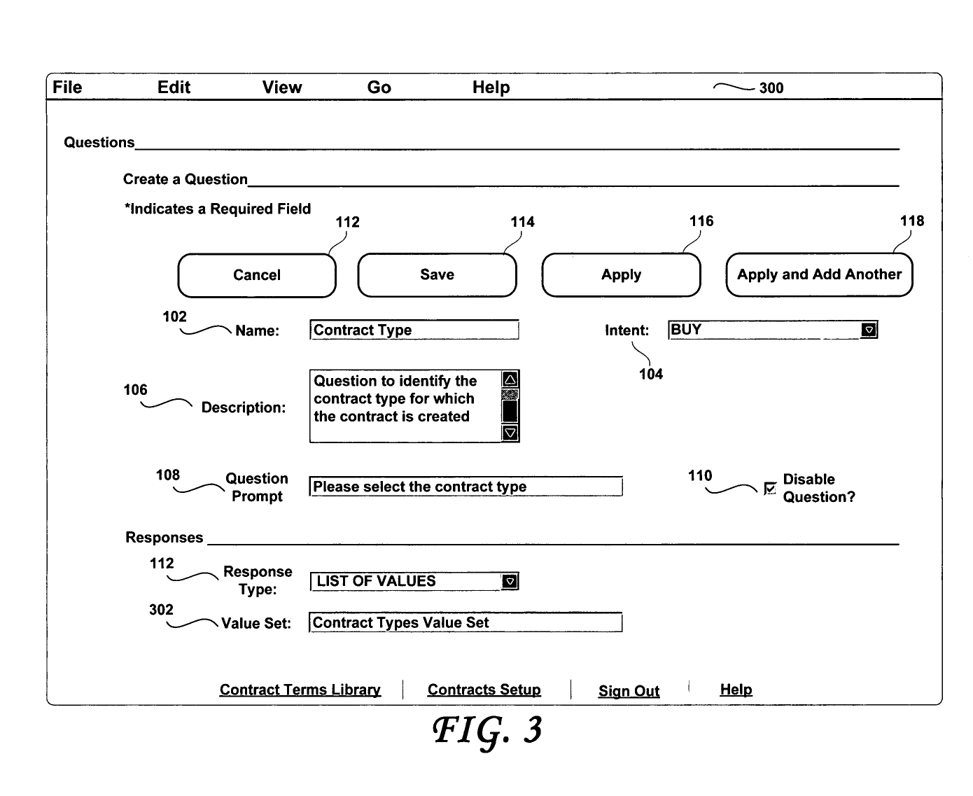

In addition to the ability to create user-defined questions, the user may define and delimit the type of response that is allowable and appropriate for a given user-created question during contract authoring process of FIG. 5. The response or answer to the question, therefore, may be a forced choice in which the type of response is predefined and the choices delimited to a selected few. For example, the Response Type pull-down menu 112 may enable the user to select from several response types, such as ‘Yes/No’, ‘Numerical’ and ‘List of Values’, for example. The ‘Yes/No’ response type shown in FIG. 1 should be selected when the appropriate answer to the user-defined question is either ‘Yes’ or ‘No’. As shown in the exemplary user interface 200 of FIG. 2, when the appropriate answer to the user-defined question is a numerical value, the creator of the user-defined question may restrict the answer to numerical values using this field 112. Specific numerical ranges may be defined and selected, as appropriate. A numeric response may be based on a pre-defined set of values or values provided by user during question creation, as shown at 202 in FIG. 2. When the answer to a user-defined question is not ‘Yes’ or ‘No’ or numerical, the question creator may specify a List of Values (LOV) as appropriate response to the question, as shown in the exemplary user interface 300 of FIG. 3. For example, the allowable answers (selectable from a dropdown list, for example) for a question whose answer is restricted to a LOV 302 may include, for example, “Fixed Price’, ‘Cost Plus Pricing’, ‘Services Only Pricing’ (for example), as its enumerated list of allowable responses.

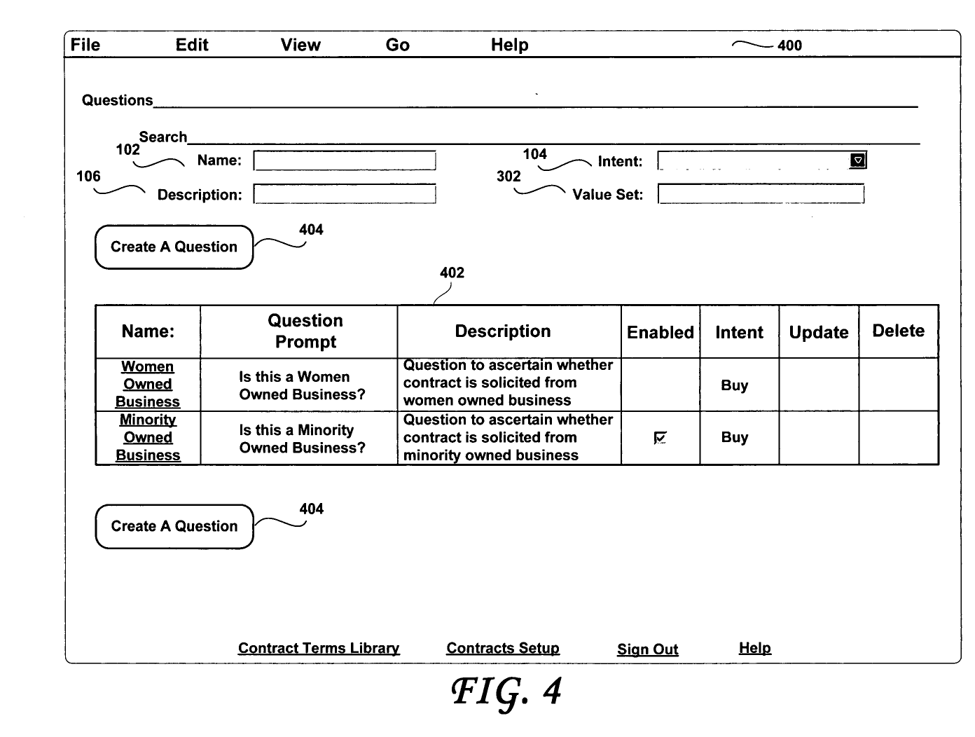

Embodiments of the present invention enable a user to search for a question based upon search criteria, as shown in FIG. 4. The search criteria may include, for example, one or more of the name field 102, the intent filed 104, the description field 106 and/or the value Set Field 302. One or more questions may be displayed in response to the execution of the search, as shown at 402. If none of the questions satisfy the search criteria, the user may choose to create a new user-defined question by depressing the “Create a Question” button, shown in FIG. 4 at 404.

Rules are the structured data representation of the logic that determine which terms and conditions should be included in the contract. The clause selection rules are intended for use by automated processes of the application 506 incorporating embodiments and aspects of the present invention. Rules are evaluated by such automated processes and may incorporate one or more clauses into the customized contract 510 being created. However, evaluation of the rules need not result in any additional clauses being incorporated into the customized contract 510. Rules may, but need not, include one or more user-defined questions, the user provided answers to which cause the evaluation of one or more rules that, in turn, may cause the incorporation of one or more clauses into the contract. For example, a rule may state that if Payment Terms in a contract is “Net 30”, then the “Special Payment Terms” clause is to be incorporated into the contract.

As noted above, the evaluation of rules may cause more than one clause to be incorporated into a contract. An example of such a rule may be “If the Purchase Order is greater than $1,000,000 incorporate in Clauses A, B and C.” In this case, the rules of the selected template will compare the value of the contract from the document against the threshold defined in the rules (in this case $1,000,000) and determine whether to incorporate in clauses A, B and C.

User-created rules may be simple or complex. Another simple rule may use a couple of conditions to drive Clause selection. An example of a simple rule might be: “Select Clause 52.102.3 if Item Category is ‘Commercial’ and supplier is a ‘women-owned business’”. More complex rules may use Boolean operators and criteria including, amounts, system variables and user questions and responses. For instance, a complex rule might be “Select Clause 52.210.5 if document type is ‘PO or RFQ or RFI or Blanket Purchase Agreement’ and Customer type is ‘Government Contractor’ and transaction type is ‘International’ and acquisition value exceeds the ‘Simple Acquisition Threshold’.

Complex rules may be defined that depend upon the execution and result of one or more other rules. Such complex rules may incorporate one or more questions, the responses to which may drive the application 506 to prompt the user for the answers to additional questions. For instance, if the answer to the question ‘Does solicitation require cost or pricing data?’ is ‘No’, another question may be posed to the user, such as, for example ‘Use format prescribed in Table 15-2 of Section 15.402?’ Based on the combination of the responses to these questions, the application incorporating an embodiment of the present invention may incorporate one or more predetermined clauses into the contract (and/or take out one or more clauses previously contained in the contract).

According to an embodiment of the present invention, such dependencies may be organized as a hierarchy of questions. Indeed, embodiments of the present invention enable the user to create a hierarchy of dependent questions that drive the selection of clauses in the contract. The table below is an example of a hierarchy of user-defined rules that incorporate one or more user-defined questions that drive the selection of an exemplary FAR Clause 52.215-20 or one of its alternates.

| Condition | Result |
|---|---|
| Does the solicitation | If No, ask another question ‘Use |
| require cost or pricing | format prescribed in Table 15-2 |
| data or other | of Section 15.402? |
| information? | If Yes, select Clause ’52.215-20’ |
| Use format prescribed | If ‘No’, ask another question, |
| in Table 15-2 of | ‘Send copies of proposal to ACO |
| Section 15.402? | and Contract Auditor?’ |
| | If Yes, select Clause ’52.215-20 |
| | Alternate 1’ |
| Send copies of | If ‘No’, ask another question, |
| proposal to ACO and | ‘Require submission via electronic |
| Contract Auditor? | mail?’ |
| | If ‘Yes’, select Clause |
| | ’52.215-20 Alternate II’ |
| Require submission | If ‘No’, ask another question, |
| via electronic mail? | ‘Require other info per 15.408-3?’ |
| | If ‘Yes’, select Clause |
| | ‘52.215-20 Alternate III’ |
| Require other info | If ‘Yes’, select Clause |
| per 15.408-3? | ‘’52.215-20 Alternate IIV’ |

The example above illustrates questions that should be answered in a predetermined or hierarchical sequence. As the responses are provided, it is determined whether one or more subsequent questions are relevant and should be asked. During and/or at the conclusion of this process, the application 506 will select the appropriate clause(s) to be included in a contract document and/or canceled therefrom.

Embodiments of the present invention allow one or more rules to be associated with a template 502 that is used to author a customized contract 510. Such a rule or rules that are associated with a contract template 502 may then be applied whenever the template 502 is used to author a customized contract 510. These rules may be user-created and may include one or more user-created questions. In this manner, when a contract template 502 is used, the user may be prompted to provide responses to any questions within the rule or rules of the selected contract template 502. Additional rules are then applied against the user-provided responses to these questions, to drive the selection of additional clauses to incorporate into the customized contract 510 and/or the de-selection of clauses that should not appear in the customized contract 510.

Further embodiments of the present invention enable rules to be applied to all contracts 502 within an organization (organization-level rules) or only to contracts that use specific templates. Also, global rules may be defined that apply to all or a selected set of templates. When users within that predetermined division author a contract using a contract template such as shown at 502 in FIG. 5, the organization-level rules will apply and answers to the organization-level rules must be provided to generate a customized contract, as shown at 510. Additionally, the rules that are applicable for that specific template are evaluated.

In addition to the Boolean operators (e.g., AND, OR, XOR, NOT and the like), rules may be user configured and defined to include other logic operators such as IS, IN and NOT IN. Numerical condition operators, such as ‘>=’ (Greater or equal to), ‘<=’ (less than or equal to), ‘=’ (Equal to), ‘>’ (Greater than) or ‘<’ (Lesser than) may also be used to define conditions in user-defined rules. It is understood that the user may specify the result of a rule if the conditions defined by the rule are met. Such results, for example, may include the inclusion of one or more clauses into the customized contract 510 or the prompting one or more questions to evaluate user responses to further drive the clause selection process.

Embodiments of the present invention may define questions (and/or rules driven by such user-defined questions) that are based on a single variable, such as “Payment Terms”. For example, a rule may be defined having the form of “Incorporate ‘Clause A’ if Payment Terms=Net 60. Such a rule would incorporate Clause A into the customized contract 510 when the payment term of a contract is “Net 60”. Rules may also be user-defined that are based on multiple values of the same variable using, for example, Boolean operators. In this manner, a rule may be defined by the user of the form “Incorporate ‘Clause A’ if Payment Terms=Net 60 OR Net 75”. Such a rule would incorporate Clause A into the customized contract 510 when the answer to a payment term question is either ‘Net 60’ or ‘Net 75’. According to a further embodiment of the present invention, users may enter multiple values for a single condition. The operator ‘In’ or ‘Not In’ may be used to define a condition having multiple values. A multi-select List Of Values (LOV) may be opened to enable users to select multiple values as illustrated in the example below, which is an exemplary rule ‘Incorporate in Clause “Special Defense Clause”’. Such a rule may be have the form of: Select ‘Clause’ ‘Special Defense Obligations’ if:
1. PO Amount>Simple Acquisition Threshold AND
2. Defense Funds Obligated? Is answered ‘No’ AND
3. Contract Type In (Commercial Items, Simple Acquisition Procedures, Construction Projects).

In this example, the Special Defense Obligations contract clause will be incorporated into the contract when all three of the conditions enumerated above hold true, causing this clause to be stored in the database 504 and incorporated into the customized contract 510.

Rules may also be defined that incorporate in multiple clauses into the customized contract 510, based upon the value of the answer given in response to a user-defined question. An example of the format of such a rule is “Incorporate ‘Clause A’ and ‘Clause B’ if Customer Category=‘Government’”. Still other rules may be defined to incorporate in clauses into the customized contract 510 based upon multiple conditions based on values of answers to user questions and variables. For example, the format of such a rule may take the form of “Incorporate ‘Clause A’ and ‘Clause B’ if Customer Category=‘Government’ and Payment Terms=‘Immediate’. According to such a rule, Clauses A and B would be incorporated into the contract 510 if the Customer Category is ‘Government’ and the Payment Terms is ‘Immediate’. Using the previous example, Clauses A and B may be made mandatory by a rule having the form of: “Incorporate ‘Clause A’ and ‘Clause B’ if Customer Category=‘Government’ and Payment Terms=‘Immediate’ AND ‘Clause A’ and ‘Clause B’ are ‘Mandatory’. In contradistinction, clauses may also be tagged as ‘Optional’, meaning that their inclusion is not mandatory and that they may be deleted from any resulting customized contract 510. Questions, as discussed herein, may be configured so as to be dependent on one or more other questions. Rules may be defined that are based upon such dependent user-defined questions, and the user-defined rule may dictate different outcomes (e.g., the inclusion and/or exclusion of different clauses) based upon the answers to such dependent user-defined questions. For example, a rule may be configured and defined by the user of the form “If answer to ‘Question A’ is ‘Yes’, ask ‘Question B’. If answer to ‘Question A’ is ‘No’, incorporate ‘Clause C’. If answer to ‘Question B’ is ‘Yes’, incorporate ‘Clause A’. If answer to ‘Question B’ is ‘No’, incorporate ‘Clause B’. Other forms of rules may be defined, and all such types and forms of user-defined rules for incorporating or taking out clauses into a contract are within the scope of the present invention. For example, rules based upon other Boolean operators and combining more than one form of rules may readily be defined within the context of the present embodiments.

After a rule or a hierarchy of rules are defined by the user, it or they may be assigned to and incorporated into a new template to be stored in the database 504 and/or incorporated into one of the contract templates 502 already stored in the database 504. When a user-defined rule within a template 502 is evaluated based upon previously known information and/or information provided by the user in response to the rule's question or questions, the clause or clauses to be incorporated into the customized contract 510 may be fetched from the contract terms library in the database 504. After the new clauses are added and/or not needed clauses are taken out of the customized contract 510, the remaining clauses may be reordered by the user as appropriate to create a well-formatted contract.

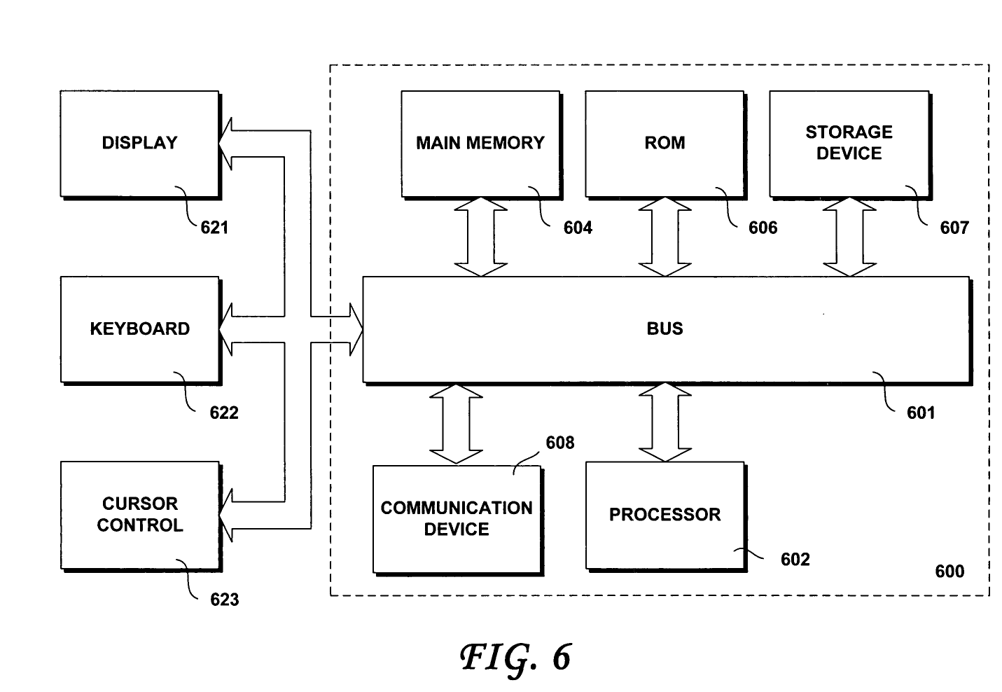

FIG. 6 illustrates a block diagram of a computer system 600 upon which embodiments of the present inventions may be implemented. Computer system 600 includes a bus 601 or other communication mechanism for communicating information, and one or more processors 602 coupled with bus 601 for processing information. Computer system 600 further comprises a random access memory (RAM) or other dynamic storage device 604 (referred to as main memory), coupled to bus 601 for storing information and instructions to be executed by processor(s) 602. Main memory 604 also may be used for storing temporary variables or other intermediate information during execution of instructions by processor 602. Computer system 600 also includes a read only memory (ROM) and/or other static storage device 606 coupled to bus 601 for storing static information and instructions for processor 602. A data storage device 607, such as a magnetic disk or optical disk, is coupled to bus 601 for storing information and instructions. The computer system 600 may also be coupled via the bus 601 to a display device 621 for displaying information to a computer user. An alphanumeric input device 622, including alphanumeric and other keys, is typically coupled to bus 601 for communicating information and command selections to processor(s) 602. Another type of user input device is cursor control 623, such as a mouse, a trackball, or cursor direction keys for communicating direction information and command selections to processor 602 and for controlling cursor movement on display 621.

Embodiments of the present invention are related to the use of computer system 600 and/or to a plurality of such computer systems to enable methods and systems for authoring contracts. According to one embodiment, the methods for authoring of contracts described herein may be provided by one or more computer systems 600 in response to processor(s) 602 executing sequences of instructions contained in memory 604. Such instructions may be read into memory 604 from another computer-readable medium, such as data storage device 607 Execution of the sequences of instructions contained in memory 604 causes processor(s) 602 to perform the steps and have the functionality described herein. In alternative embodiments, hard-wired circuitry may be used in place of or in combination with software instructions to implement the present invention. Thus, the present invention is not limited to any specific combination of hardware circuitry and software.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below.

What is claimed is:

1. A computer-implemented method of authoring a contract, the method comprising the steps of:
providing a database that includes a plurality of selectable contract clauses and a plurality of selectable contract templates each of the plurality of contract templates including a plurality of rules, each of the plurality of rules being configured to incorporate at least one selected contract clause into the contract to be authored depending upon an evaluation of the rule;
selecting a contract template from among a plurality of contract templates;
evaluating each of the plurality of rules in the selected contract template;
receiving a user response to a question when at least one of the plurality of rules in the selected contract template includes a question requiring a response by the user;
determining whether one or more additional contract clauses should be added to the contract depending on the evaluation step and any received user responses;
when the determining step determines that a contract clause should be added to the contract, selecting and retrieving from the database, at least one contract clause for inclusion in the contract, and
generating a customized contract based upon the selected contract template, the customized contract being configured to include the at least one selected and retrieved contract clause.

2. The computer-implemented method of claim 1, wherein at least one of the plurality of rules is user-defined.

3. The computer-implemented step of claim 2, wherein the user-define rule includes at least one user-defined question.

4. The computer-implemented method of claim 1, wherein the user response is a forced choice that is constrained to a specific type of answer or to a predefined number of possible values.

5. The computer-implemented method of claim 4, wherein the specific type of answer includes one of YES/NO and numerical answers.

6. The computer-implemented method of claim 2, wherein the at least one user-defined rule is configured to accept as an answer only a value selected from a provided list of values.

7. The computer-implemented method of claim 2, wherein the user-defined rule includes a Boolean operator.

8. The computer-implemented method of claim 2, wherein the user-defined rule is configured to selectively cause execution of another rule depending upon an answer provided by the user in response to the user-defined question.

9. The computer-implemented method of claim 1, wherein each of the plurality of selectable contract templates includes at least one pre-seeded contract clause.

10. A machine-readable medium having data stored thereon representing sequences of instructions which, when executed by a computing device causes the computing device to author a contract by carrying out steps including:
providing a database that includes a plurality of selectable contract clauses and a plurality of selectable contract templates, each of the plurality of contract templates including a plurality of rules, each of the plurality of rules being configured to incorporate at least one selected contract clause into the contract to be authored depending upon an evaluation of the rule;
selecting a contract template from among a plurality of contract templates;
evaluating each of the plurality of rules in the selected contract template;
receiving a user response to a question when at least one of the plurality of rules in the selected contract template includes a question requiring a response by the user;
determining whether one or more additional contract clauses should be added to the contract depending on the evaluation step and any received user responses;
when the determining step determines that a contract clause should be added to the contract, selecting and retrieving from the database, at least one contract clause for inclusion in the contract, and
generating a customized contract based upon the selected contract template, the customized contract being configured to include the at least one selected and retrieved contract clause.

11. The machine-readable medium of claim 10, wherein at least one of the plurality of rules is user-defined.

12. The machine-readable medium of claim 11, wherein the at least one user-defined rule includes at least one user-defined question.

13. The machine-readable medium of claim 10, wherein the user response is a forced choice that is constrained to a specific type of answer or to a predefined number of possible values.

14. The machine-readable medium of claim 13, wherein the specific type of answer includes one of YES/NO and numerical answers.

15. The machine-readable medium of claim 11, wherein the at least one user-defined rule is configured to accept as an answer only a value selected from a provided list of values.

16. The machine-readable medium of claim 11, wherein the user-defined rule includes a Boolean operator.

17. The machine-readable medium of claim 11, wherein the user-defined rule is configured to selectively cause execution of another rule depending upon an answer provided by the user in response to the user-defined question.

18. The machine-readable medium of claim 10, wherein each of the plurality of selectable contract templates includes at least one pre-seeded contract clause.

19. A computer system for authoring a contract, the computer system comprising:
at least one processor;
at least one data storage device coupled to the at least one processor;
a plurality of processes spawned by said at least one processor, the processes including processing logic for:
providing a database that includes a plurality of selectable contract clauses and a plurality of selectable contract templates, each of the plurality of contract templates including a plurality of rules, each of the plurality of rules being configured to incorporate at least one selected contract clause into the contract to be authored depending upon an evaluation of the rule;
selecting a contract template from among a plurality of contract templates;
evaluating each of the plurality of rules in the selected contract template;
receiving a user response to a question when at least one of the plurality of rules in the selected contract template includes a question requiring a response by the user;
determining whether one or more additional contract clauses should be added to the contract depending on the evaluation step and any received user responses;
when the determining step determines that a contract clause should be added to the contract, selecting and retrieving from the database, at least one contract clause for inclusion in the contract, and
generating a customized contract based upon the selected contract template, the customized contract being configured to include the at least one selected and retrieved contract clause.

20. The computer system of claim 19, wherein at least one of the plurality of rules is user-defined.

21. The computer system of claim 20, wherein the at least one user-defined rule includes at least one user-defined question.

22. The computer system of claim 19, wherein the user response is a forced choice that is constrained to a specific type of answer or to a predefined number of possible values.

23. The computer system of claim 22, wherein the specific type of answer includes one of YES/NO and numerical answers.

24. The computer system of claim 20, wherein the at least one user-defined rule is configured to accept as an answer only a value selected from a provided list of values.

25. The computer system of claim 20, wherein the user-defined rule includes a Boolean operator.

26. The computer system of claim 20, wherein the user-defined rule is configured to selectively cause execution of another rule depending upon an answer provided by the user in response to the user-defined question.

27. The computer system of claim 19, wherein each of the plurality of selectable contract templates includes at least one pre-seeded contract clause.
